(19) United States
(12) Patent Application Publication
(10) Pub. No.: US 2020/0309301 A1
(43) Pub. Date: Oct. 1, 2020

(54) QUICK CONNECT COUPLING

(71) Applicant: Dixon Valve & Coupling Company, LLC, Chestertown, MD (US)

(72) Inventors: Matthew Micken, Millington, MD (US); James Shifrin, Chestertown, MD (US); Sean Wilcox, Middletown, DE (US); William Wagers, Chestertown, MD (US)

(21) Appl. No.: 16/830,965

(22) Filed: Mar. 26, 2020

Related U.S. Application Data
(60) Provisional application No. 62/824,370, filed on Mar. 27, 2019.

(51) Int. Cl. F16L 37/124; F16L 23/16

(52) U.S. Cl. CPC F16L 37/124; F16L 23/162

(57) ABSTRACT

A coupling for interconnecting pipes, hoses, or the like, includes a male coupling component configured to form a coupling with one or more female coupling components. The male coupling component comprises an annular, hollow body portion having a nose at one end defining an annular sealing surface and a locking ring mounted on an exterior of the body portion adjacent the nose. The locking ring has at least one slotted-opening extending longitudinally therethrough and is rotatable and translatable relative to and about the hollow body portion. A female coupling components is able to be locked to the male coupling component via engagement with the locking ring of the male coupling component.

### CROSS REFERENCE TO RELATED APPLICATIONS

This application claims the benefit under 35 USC § 119(e) of U.S. Provisional Patent Application No. 62/824,370, filed Mar. 27, 2019.

### BACKGROUND

This disclosure relates to a coupling for interconnecting pipes, hoses, or the like and may be used, for instance, as an alternative or a replacement for so-called “hammer union” fittings.

A hammer union is a fitting/coupling used to connect adjacent sections of pipes or hose. For instance, see the hammer union fitting disclosed in U.S. Pat. No. 2,318,112 issued to Stillwagon. Also see the hammer union fittings, such as FIGS. 100 and 206 hammer union fittings, shown herein in FIGS. 1-3. The conventional hammer union includes three primary components: the male sub; the female sub; and a nut. In some instances, an O-ring is carried within the male sub component depending upon the pressure rating of the hammer union.

A problem with existing hammer union fittings is that they are designed to be tightened/untightened with the use of a large sledgehammer or maul or a large wrench. For instance, see the sledge hammer shown in FIG. 1. The use of these hammers can lead to accidents. In addition, a large amount of space or room around and adjacent to the fitting is required in order to have sufficient space to be able to swing the hammer and hit the nut of the fitting with the large hammer to cause rotation of the connecting nut.

FIG. 2 provides a cross-sectional view of a typical hammer union. A pair of coupling members or subs are secured together with an outer nut. A rubber O-ring may be used between the two parts for sealing the mating surfaces. FIG. 3 shows an operator tightening a conventional hammer union nut using a special wrench. This also takes considerable space, strains the operator, and provides many potential dangers to the operator.

### SUMMARY

According to one embodiment, a coupling is provided for interconnecting pipes, hoses, or the like, and comprises a male coupling component and a female coupling component. The male coupling component includes an annular, hollow body portion, which provides a nose at one end thereof defining an annular sealing surface, and a locking ring mounted on an exterior of the hollow body portion adjacent the nose. The locking ring has at least one slotted-opening extending longitudinally therethrough and being rotatable and translatable relative to and about the hollow body portion. The female coupling component comprises an annular body portion for receiving the nose of the male coupling component and a front mating face including at least one shoulder bolt for extending through the at least one slotted-opening of the locking ring of the male coupling component.

According to another embodiment, a coupling for interconnecting pipes, hoses, or the like, includes a universal male coupling component configured to form a coupling with at least two differently configured female coupling components. The male coupling component comprises an annular, hollow body portion having a nose at one end defining an annular sealing surface, a circumferentially-extending flange extending outward from the hollow body portion adjacent the nose, and a locking ring mounted on an exterior of the body portion adjacent an opposite side of the flange relative to the nose. The locking ring may have at least one slotted-opening extending longitudinally therethrough and may be rotatable relative to and about the body portion. One of the female coupling components is able to be locked to the male coupling component via engagement with the locking ring of the male coupling component and the other of the female coupling components is able to be locked to the male coupling component via engagement with the circumferentially-extending flange of the male coupling component.

According to further embodiment, a female coupling component comprises an annular body portion for receiving a nose of a male coupling component and a front mating face including at least one shoulder bolt for extending through an at least one slotted-opening of a locking ring of the male component.

According to yet another embodiment, a female coupling component comprises an annular body portion, a yoke, and a camming mechanism. The yoke may include a slot for engaging a circumferentially-extending flange of a male coupling component, and the camming mechanism may include a pair of opposed brackets interconnected by a handle and secured to an outer peripheral surface of the annular body portion of the female coupling component such that the brackets are able to pivot relative to the annular body portion between a locking position and an unlocking position. Each of the brackets may include a slot in which a bolt extending from an outer peripheral surface of the yoke is captured such that the bolt is slidable within the slot. Whereby, when the bolts are located in distal ends of the slots relative to the annular body portion of the female coupling component, the male component may be placed on or removed from the yoke, and when the bolts are slid to proximal ends of the slots relative to the annular body portion of the female coupling component, the nose of the male coupling component is driven into and becomes locked within the annular body portion of the female coupling component.

### BRIEF DESCRIPTION OF THE DRAWINGS

FIG. 1 is an image of a hammer union nut being installed with a sledgehammer according to the prior art.

FIG. 2 is a cross-sectional view of a hammer union fitting according to the prior art.

FIG. 3 is an image of a hammer union nut being installed with a wrench according to the prior art.

FIG. 4 is a perspective view of a male component of a coupling according to an embodiment.

FIG. 5 is a perspective view of a female twist-to-lock component of a coupling according to an embodiment.

FIG. 6 is an exploded perspective view of a coupling including the male component of FIG. 4 and the female twist-to-lock component of FIG. 5 according to an embodiment.

FIG. 7 is a perspective view of a female mechanical-assist component of a coupling according to an embodiment.

FIG. 8 is an exploded perspective view of a coupling including the male component of FIG. 4 and the female mechanical-assist component of FIG. 7 according to an embodiment.

FIG. 9 is a perspective view of a coupling of alternate embodiment of a male component and an alternate embodiment of a female twist-to-lock component according to an embodiment.

FIG. 10 is a cross-sectional view of the coupling of FIG. 9.

### DETAILED DESCRIPTION

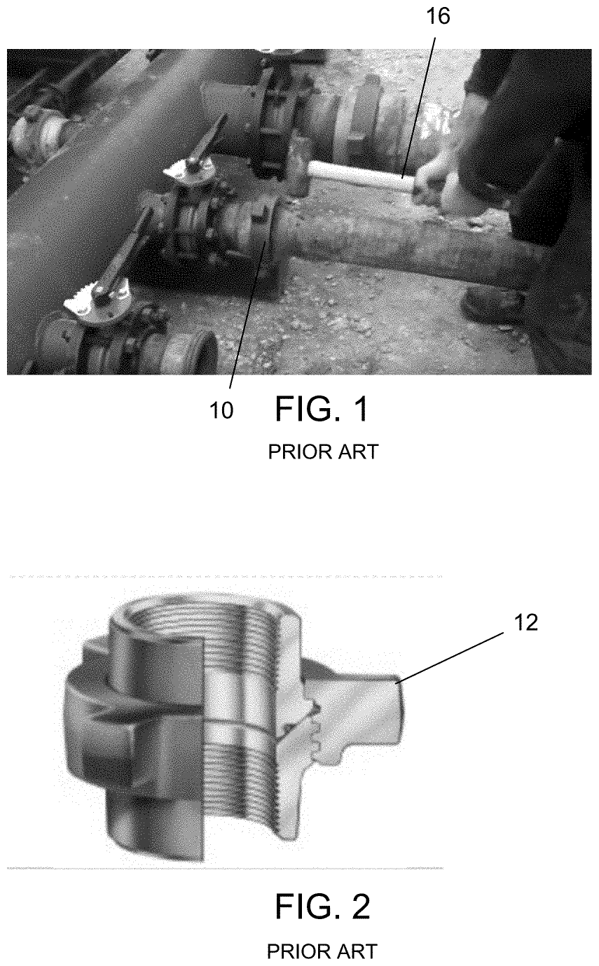

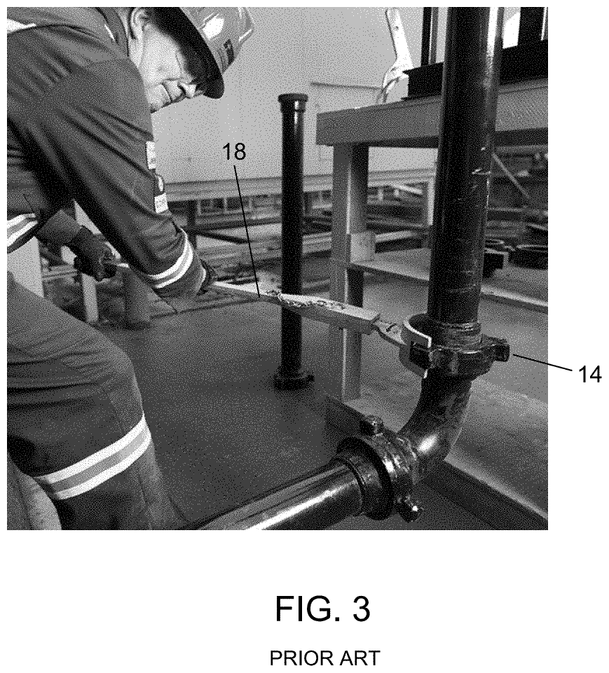

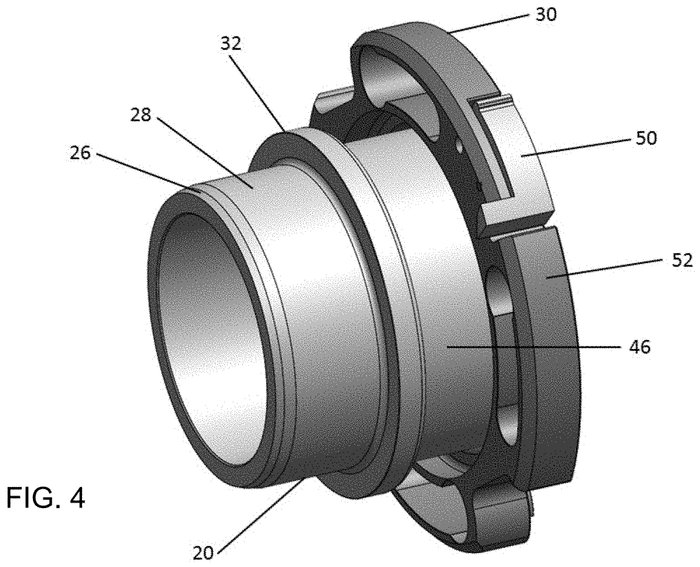

According to an embodiment, a coupling is provided that can be used as a replacement for a conventional hammer union fitting. While conventional hammer union fittings 10, 12 and 14 require the use of a large sledge hammer 16 or other large wrench 18 (see FIGS. 1-3), embodiments of couplings disclosed herein (see FIGS. 4-10) do not require the use of a tool (such as a hammer or wrench) to engage and install or disengage and uninstall the coupling. Accordingly, the couplings disclosed herein are installed by hand, do not require the use of any tools, and can provide a leak-tight and pressure capable coupling. Thus, the embodiments disclosed herein eliminate the risk of using large hammers or wrenches, enable adjacent couplings to be placed closer together as less room is needed to install or uninstall the couplings, and make the couplings easier and quicker to install/uninstall and more reliable to use.

According to an embodiment, a coupling may be comprised of a universal male component and one or two different female components.

As shown in FIG. 4, an embodiment of a the male component 20 has a nose piece 26 that can be engaged with a female component, 22 or 24, and has a sealing surface 28 machined thereon. The male component 20 also includes a locking/twist ring 30 and a circumferentially-extending flange or bump 32 which enable the male component 20 to be universally connected to multiple different female components, such as female components 22 and 24.

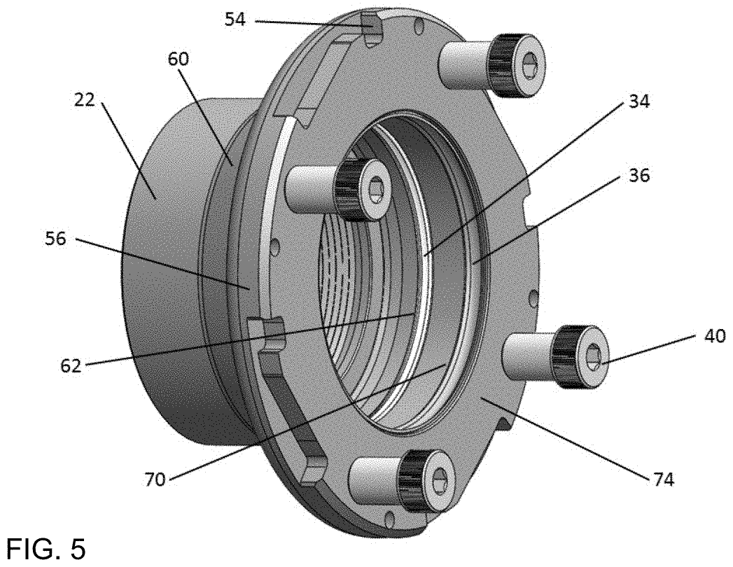

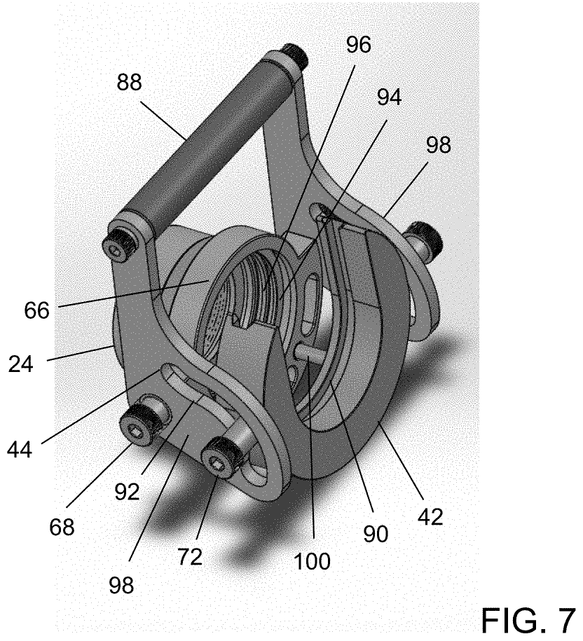

One of the female components, 22, is a twist-to-lock female component (see FIG. 5) having at least one pressure seal, such as O-rings, or X-rings, 34 and a wiper seal 36 in machined grooves on the inner surface 38 of the female component 22 and an array of spaced-apart shoulder bolts 40, such as at least two shoulder bolts 40, that are used to engage with the locking ring 30 on the male component 20. Another one of the female components, 24, may be a mechanical-assist female component (see FIG. 7) that has a yoke 42 with a slot 90 in which the male component 20 may be inserted and a cam-action mechanical system 44 that engages and/or disengages the sealing surfaces of the male and female components, 20 and 24.

Each of the above referenced embodiments of couplings are discussed in greater detail below.

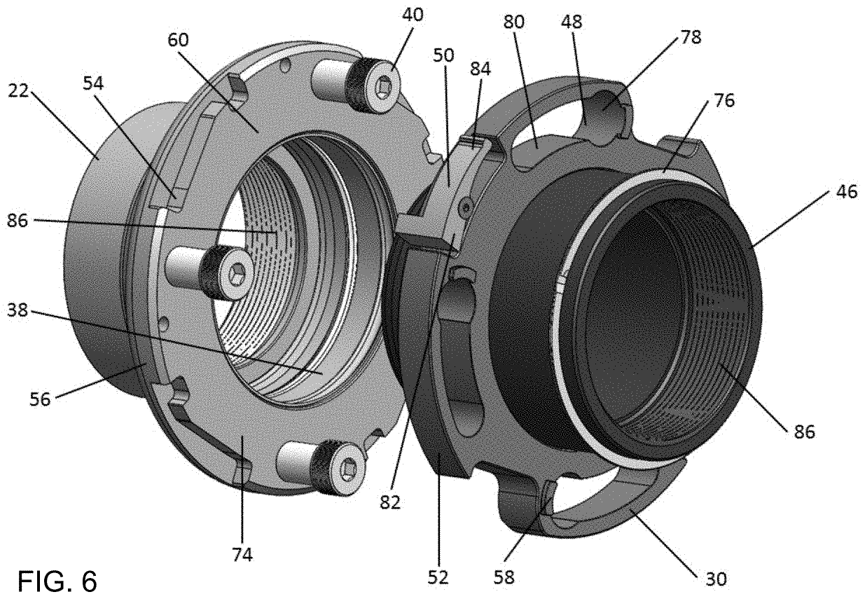

The universal male component 20 includes a main body 46 about which the twist/locking ring 30 is free to rotate and translate. The twist/locking ring 30 contains slotted openings 48 extending longitudinally therethrough which are sized to accept the shoulder bolts 40 on the female twist-to-lock component 22 (see FIG. 6) and to then twist to a locked position which keeps the male and female components, 20 and 22, locked together. A locking lever 50 along the outer periphery 52 of the twist/locking ring 30 passively and resiliently engages indentations 54 formed on an outer periphery 56 of the female component 22 and thereby prevents the twist/locking ring 30 from rotating back to an unlocked position. The locking lever 50 must be depressed by an operator to allow the locking ring 30 to rotate to the unlocking position to permit the shoulder bolts 40 to be extended back through the slotted openings 48 of the twist/locking ring 30. The twist/locking ring 30 also has bumpers 58 so that, when the twist/locking ring 30 is twisted to the unlock position, the twist/locking ring 30 stops such that the bolts 40 are able to clear the ring 30.

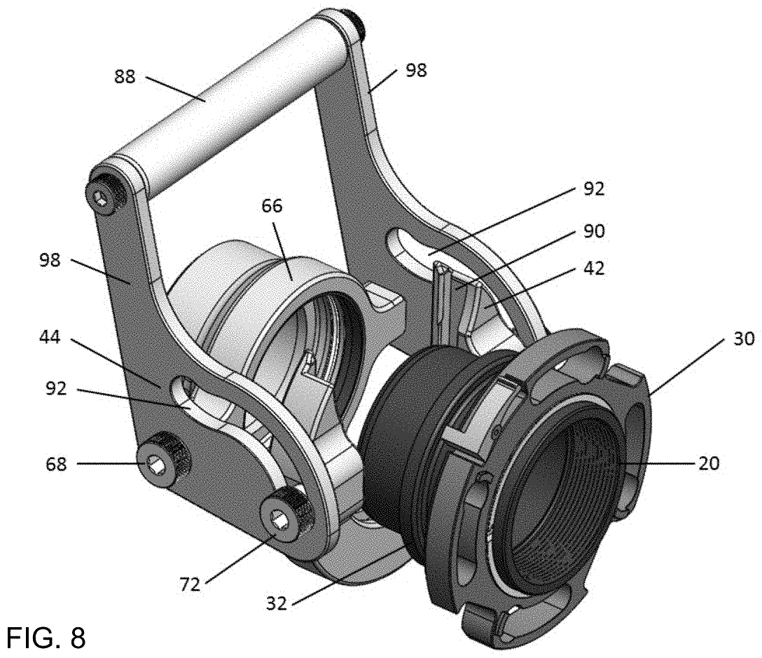

The flange ring 32 of the male component 20 allows the male component 20 to also form a coupling with the mechanical-assist female component 24. See FIG. 8. The flange ring 32 may be engaged in the slot 90 of the yoke 42 of the female component 24. Thus, the male component is universal and can be used on either of the female twist-to-lock or female mechanical-assist components, 22 and 24.

The female twist-to-lock component 22 (see FIG. 5) has no moving parts and is made up primarily of an annular body 60, at least one pressure seal groove 62, in which at least one pressure seal 34 is mounted, and one wiper seal groove 70 in which a wiper seal 36 is mounted (for instance, see FIG. 5). In addition, the female component 22 has two or more shoulder bolts 40 extending from a mating front surface 74 to engage the twist/locking ring 30 on the male component 20 and two or more peripheral areas of profile or indentations 54 corresponding to the array of shoulder bolts 40 on an outer edge thereof used to engage the locking lever 50 of the male component 20.

The purpose of the wiper seal 36 is to wipe the sealing surface 28 of the nose 26 of the male component 20 prior to the sealing surface 28 engaging the at least one pressure seal, such as an O-ring or X-ring 34, which provides a sealing function between the male and female components, 20 and 22. The shoulder bolts 40 of the female component 22 engage the twist/locking ring 30 on the male component 20 and transfer the load due to internal pressure from the female component 22 to the male component 20.

The male component 20 of the coupling (for instance, see FIGS. 4 and 6) is sized to mate with the female component 22 and the locking ring 30 is able to swivel or translate relative to the main body portion 46. The locking ring 30 may be held in place on the main body portion 46 with a snap ring 76 or the like. The locking lever 50 is a passive locking device that, in use, is able to lock the locking ring 30 to the female component 22. For instance, after the shoulder bolts 40 are extended into an enlarged opening 78 in the slotted opening 48 formed in the locking ring 30 and the locking ring 30 is rotated or turned (in a clockwise direction as shown in FIG. 6) to a full lock position, the shoulder bolts 40 become captured within a narrower section 80 of the slotted opening 48 thereby securing the coupling. In this condition, an end 82 of the locking lever 50 resiliently pivots and extends within one of the indentations 54 of the female component 22.

Thus, during installation, the male component 20 is manually pushed against the front mounting face 74 of the female component 22 of the coupling and the locking ring 30 is manually turned (for about 35°) to automatically lock the coupling in place with the locking lever 50. Uninstalling or unlocking the coupling is also a manual operation and merely requires the operator to depress an opposite end 84 of the locking lever 50 to pivot the locking lever 50 out of the indentation 54 and to turn or rotate the locking ring 30 in a counter-clockwise direction as shown in FIG. 6. When the shoulder bolts 40 align with the enlarged openings 78 of the slotted openings 48, the male and female components, 20 and 22, of the coupling may be manually separated. In testing this fitting/coupling engagement of the male and female components, 20 and 22, it has been shown to require less than 40 pounds of force to connect the two components, 20 and 22, of the coupling and almost no effort to swivel the locking ring 30.

Each of the components discussed above are illustrated as have internal threads 86 for connecting to a pipe or the like. Alternate embodiments may utilize internal and/or external threads, weld bevels or have a bolt flange or hose stem that may be machined on one or both components, 20 and 22, for making a connection to a hose or the like. Thus, the coupling may be adapted as a fitting for a hose and/or pipe.

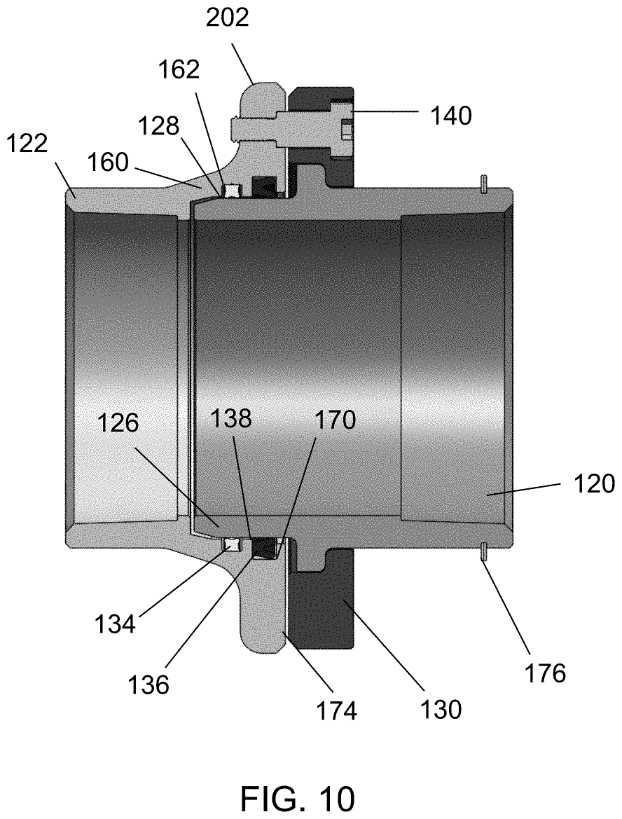

According to a second embodiment of a coupling, as shown for instance in FIG. 10, using the same male component 20 as discussed above, a hose end on which the male component 20 is secured may be placed into the yoke 42 of the female component 24 and a handle mechanism 88 of the female component 24 may then be used to make the connection/coupling between the male and female, 20 and 24, components. The handle mechanism 88 may be designed to pivot “over center” so that it is self-locking under pressure. When disconnecting, the handle is raised (as shown in FIG. 8), and the male and female components, 20 and 24, are separated so that the hose end (i.e., male component 20) may be removed from the yoke 42.

The female mechanical-assist component 24 may be comprised of an annular body portion 66 for receiving the nose 26 of the male component 20, the yoke 42, and the camming mechanism 44, which are secured and assembled together with hinge bolts 68 (interconnecting the camming mechanism 44 to the annular body portion 66), slot bolts 72 (interconnecting the camming mechanism 44 to the yoke 42) and the handle 88 (interconnecting the opposite sides of the camming mechanism 44).

In use, the male component 20 is placed within the yoke 42 of the female component 24 by placing the flange 32 of the male component 20 within a corresponding slot 90 on the yoke 42. The connection/coupling is then made by pulling or pushing the upstanding handle (see handle position shown in FIG. 8) downward such that the slot bolts 72 slide along and within slots 92 formed in the camming mechanism 44 to an opposite end of the slots 92 which moves the yoke 42 toward the annular body portion 66. This, in turn, drives the nose 26 of the male component 20 into the annular body portion 66 and against a wiper seal 94 and then at least one pressure seal 96 within the annular body portion 66 of the female component 24 to form a coupling. The slot bolts 72 in conjunction with the guide brackets 98 of the camming mechanism 44 and the slots 92 formed by the guide brackets 98 control the motion of the male component 20 relative to the annular body portion 66 of the female component 24 and provides a mechanical-assist function.

Disconnection of the male and female components, 20 and 24, is achieved in reverse (i.e., pulling upward on the handle 88 which moves the yoke 42 away from the annular body portion 66 and thus disengages the nose 26 of the male component 20 allowing for removal of the male component 20 from the yoke 42. The motion of the yoke 42 relative to the annular body portion 66 may be controlled in a linear manner by one or more slide rods 100 (see FIG. 7) located adjacent a bottom of the yoke 42.

By way of example, and not by way of limitation, the couplings/male and female components may have a nominal diameter of 2 to 5 inches or more with a pressure rating of 500 psi and a 4:1 safety factor. In addition, the diameter of the coupling may be 6 inches or more with a pressure rating of 300 psi and a 4:1 safety factor or 8 inches or more with pressure rating of 200 psi and a 4:1 safety factor. The male and female components may be made of other sizes and may be made of aluminum, brass, stainless steel, steel and steel alloys, iron, plastic, composite materials, or the like. The seals may be made of polyurethane or like elastomeric material.

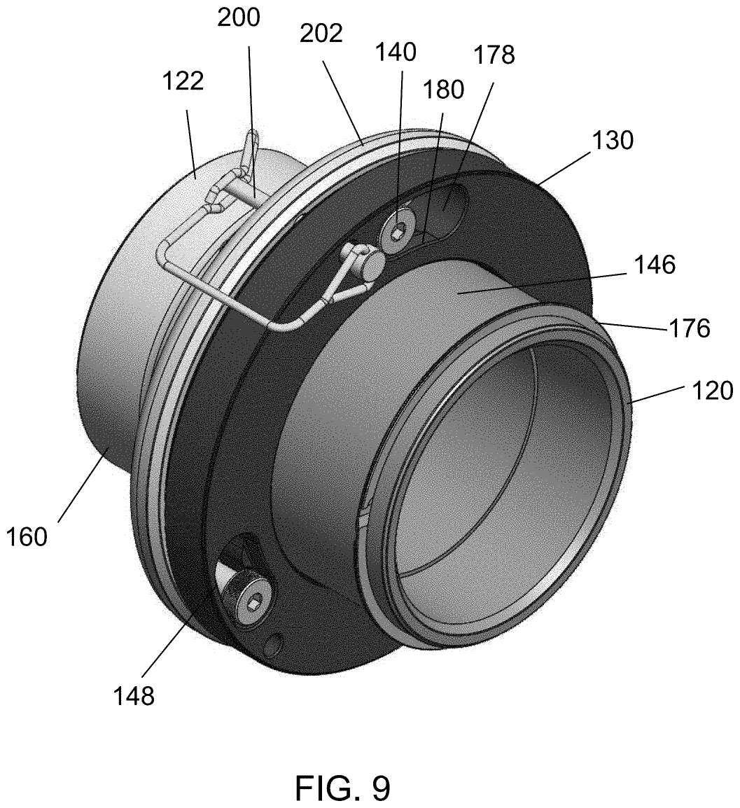

An additional embodiment of a male component 120 and a twist-to-lock female component 122 for making a coupling are shown in FIGS. 9 and 10.

Similar to the male component 20, the mail component 120 has a nose piece 126 that can be engaged with the female component 122 and has a sealing surface 128 machined thereon. The male component 120 also includes a locking/twist ring 130 which enables the male component 120 to be connected to the female components 122.

Similar to the female component 22, the female components 122 is a twist-to-lock female component having at least one pressure seal, such as O-rings, or X-rings, 134 and a wiper seal 136 in machined grooves on the inner surface 138 of the female component 122 and an array of spaced-apart shoulder bolts 140, such as three shoulder bolts 140, that are used to engage with the locking ring 130 on the male component 120.

The male component 120 includes a main body 146 about which the twist/locking ring 130 is free to rotate and translate. The twist/locking ring 130 contains slotted openings 148 extending longitudinally therethrough which are sized to accept the shoulder bolts 140 on the female twist-to-lock component 122 and to then twist to a locked position which keeps the male and female components, 120 and 122, locked together. A wire lock clevis pin 200 is used to prevent the twist/locking ring 130 from rotating back to an unlocked position. In this regard, the twist/locking ring 130 and the female component 122 have aligned openings through which the pin 200 may be extended or withdrawn.

The female twist-to-lock component 122 has no moving parts and is made up primarily of an annular body 160, at least one pressure seal groove 162, in which at least one pressure seal 134 is mounted, and one wiper seal groove 170 in which a wiper seal 136 is mounted (for instance, see FIG. 10). In addition, the female component 122 has two or more shoulder bolts 140 extending from a mating front surface 174 to engage the twist/locking ring 130 on the male component 120.

The male component 120 is sized to mate with the female component 122 and the locking ring 130 is able to swivel or translate relative to the main body portion 146. The locking ring 130 may be held in place on the main body portion 146 with a snap ring 176 or the like, which may extend two or more times about the body so as to eliminate any sharp edge. As stated above, the clevis pin 200 may be manually extended through the coupling in the position shown in FIG. 9 to lock the locking ring 130 to the female component 122. For instance, after the shoulder bolts 140 are extended into an enlarged opening 178 in the slotted opening 148 formed in the locking ring 130 and the locking ring 130 is rotated or turned to a full lock position as in FIG. 9, the shoulder bolts 140 become captured within a narrower section 180 of the slotted opening 148 thereby securing the coupling. As best shown in FIG. 10, the heads of bolts 140 are recessed into the slots 48 of the twist/locking ring 130 for purposes of protecting the bolts 140 during use, and detents (not shown) can be formed in and extend from opposed walls of the slots 148 to retain the heads of the bolts 140 in the locking position while a user inserts the clevis pin 200 through the coupling. In addition, as best shown in FIG. 10, the flange 202 of the female component 122 extends further outward in a radial direction from the coupling than the twist/locking ring 130 to permit easier hose-to-hose connections since the twist/locking ring 130 will not rest on the ground while such a connection is made.

Thus, during installation, the male component 120 is manually pushed against the front mounting face 174 of the female component 122 of the coupling and the locking ring 130 is manually turned (for about 16.5°) to automatically lock the coupling in place with the detents acting against the shoulder bolts 140 (i.e., will not open relative to forces less than about 3 to 4 psi). Thereafter, the clevis pin 200 is extended through the coupling. Uninstalling or unlocking the coupling merely requires the operator to withdraw the clevis pin 200 from the coupling and to turn or rotate the locking ring 130 with sufficient force to overcome the detents to a position enabling the shoulder bolts 140 to be extended through the slots 148. Thus, when the shoulder bolts 140 align with the enlarged openings 178 of the slotted openings 148, the male and female components, 120 and 122, of the coupling may be manually separated.

The foregoing description and specific embodiments are merely illustrative of the principles thereof, and various modifications and additions may be made to the apparatus by those skilled in the art, without departing from the spirit and scope of this invention.

We claim:

1. A coupling for interconnecting pipes, hoses, or the like, comprising a male coupling component and a female coupling component, said male coupling component comprising an annular, hollow body portion, which provides a nose at one end thereof defining an annular sealing surface, and a locking ring mounted on an exterior of said hollow body portion, said locking ring having at least one slotted-opening extending longitudinally therethrough and being rotatable and translatable relative to and about said hollow body portion.

2. The coupling according to claim 1, wherein said female coupling component comprises an annular body portion for receiving said nose of said male coupling component and a front mating face including at least one shoulder bolt for extending through said at least one slotted-opening of said locking ring of said male coupling component.

3. The coupling according to claim 2, wherein said at least one slotted-opening of said locking ring includes an enlarged-opening section for permitting passage of a head of said at least one shoulder bolt and a narrow-slot section for capturing said head of said at least one shoulder bolt and preventing said head of said at least one shoulder bolt from being released from said at least one slotted-opening.

4. The coupling according to claim 3, wherein said locking ring is rotatable between locking and unlocking positions, such that, in said unlocking position, said head of said at least one shoulder bolt is aligned with said enlarged-opening section of said slotted-opening and, such that, in said locking position, said head of said at least one shoulder bolt is aligned with said narrow-slot section.

5. The coupling according to claim 4, wherein, in said locking position, said head of said at least one shoulder bolt is recessed within said slotted-opening.

6. The coupling according to claim 5, wherein said female coupling component has a radially-outward extending flange which forms said front mating face, and wherein said radially-outward extending flange extends outward a greater distance than the locking ring of said male coupling component.

7. The coupling according to claim 4, further comprising a clevis pin that is extendable through said locking ring and said front mating face of said female coupling component to lock said male coupling component to said female coupling component in said locked position.

8. The coupling according to claim 4, wherein said locking ring has a plurality of said slotted-openings and said female coupling component has a plurality of said shoulder bolts.

9. The coupling according to claim 4, wherein said locking ring has a locking lever secured to an outer peripheral surface of said locking ring in a manner permitting said locking lever to pivot relative to said locking ring, and wherein said female coupling component includes an outer peripheral surface with at least one indentation formed therein for capturing an end of said locking lever when said locking ring is in said locking position.

10. The coupling according to claim 1, wherein said male coupling component has a circumferentially-extending flange extending outward from said hollow body portion adjacent said nose such that said locking ring is mounted on an exterior of said hollow body portion adjacent an opposite side of said flange relative to said nose, wherein said female coupling component comprises an annular body portion, a yoke, and a camming mechanism, and wherein said yoke includes a slot for engaging said circumferentially-extending flange of the male component.

11. The coupling according to claim 10, wherein said male coupling component is configured to form a coupling with two differently configured female coupling components, one of the female coupling components being configured to be locked to said male coupling component via engagement with said locking ring of said male coupling component and the other of the female coupling components being configured to be locked to said male coupling component via engagement with said circumferentially-extending flange of said male coupling component.

12. The coupling according to claim 10, wherein said camming mechanism includes a pair of opposed brackets interconnected by a handle and secured to an outer peripheral surface of the annular body portion of said female coupling component such that said brackets are able to pivot relative to the annular body portion between a locking position and an unlocking position.

13. The coupling according to claim 12, wherein each of said brackets includes a slot in which a bolt extending from an outer peripheral surface of said yoke is captured such that the bolts are slidable within the slots, whereby, when the bolts are located in distal ends of the slots relative to the annular body portion of said female coupling component, said male coupling component may be placed on or removed from said yoke, and when the bolts are slid to proximal ends of the slots relative to the annular body portion of said female coupling component, said nose of said male coupling component is driven into and locked within the annular body portion of said female coupling component.

14. The coupling according to claim 1, wherein said female coupling component includes an inner annular surface on which at least one pressure seal is mounted to create a seal between said sealing surface of said nose of said male coupling component and the inner annular surface of said female coupling component.

15. The coupling according to claim 14, wherein a wiper seal is mounted on said inner annular surface of said female coupling component in front of said at least one pressure seal relative to said male coupling component such that said sealing surface of said nose of said male coupling component is cleaned by said wiper seal before it reaches said at least one pressure seal.

16. A female coupling component of a coupling for interconnecting pipes, hoses, or the like, comprising an annular body portion for receiving a nose of a male coupling component and a front mating face including at least one shoulder bolt for extending through at least one slotted-opening of a locking ring of the male coupling component.

17. The female coupling component according to claim 16, further comprising an inner annular surface on which at least one pressure seal is mounted to create a seal between the nose of the male coupling component and the inner annular surface of said female coupling component, and further comprising a wiper seal mounted on said inner annular surface of said female coupling component in front of said at least one pressure seal relative to the male coupling component such that the nose of the male coupling component is cleaned by said wiper seal before it reaches said at least one pressure seal.

18. The female coupling component according to claim 17, wherein the female coupling component includes an outer peripheral surface with at least one indentation formed therein for capturing an end of a locking lever of the male coupling component.

19. A female coupling component of a coupling for interconnecting pipes, hoses, or the like, comprising:
an annular body portion, a yoke, and a camming mechanism;
the yoke includes a slot for engaging a circumferentially-extending flange of a male coupling component;
the camming mechanism includes a pair of opposed brackets interconnected by a handle and secured to an outer peripheral surface of the annular body portion of the female coupling component such that the brackets are able to pivot relative to the annular body portion between a locking position and an unlocking position; and
each of the brackets includes a slot in which a bolt extending from an outer peripheral surface of the yoke is captured such that the bolt is slidable within the slot;
whereby, when the bolts are located in distal ends of the slots relative to the annular body portion of the female coupling component, the male coupling component may be placed on or removed from the yoke, and when the bolts are slid to proximal ends of the slots relative to the annular body portion of the female coupling component, the nose of the male coupling component is driven into and locked within the annular body portion of the female coupling component.

20. The female coupling component according to claim 19, further comprising at least one slide rod interconnecting the yoke and annular body portion and ensuring linear movement of the yoke toward and away from the annular body portion.
